(19) United States
(12) Patent Application Publication
(10) Pub. No.: US 2005/0061101 A1
(43) Pub. Date: Mar. 24, 2005

(54) Steering pinion

(76) Inventor: Christoph Grobel, Remscheid (DE)

Correspondence Address: KATTEN MUCHIN ZAVIS ROSENMAN, 575 MADISON AVENUE, NEW YORK, NY, 10022-2585, US

(21) Appl. No.: 10/502,128

(22) PCT Filed: Dec. 12, 2003
(86) PCT No.: PCT/EP03/14131

(30) Foreign Application Priority Data
Dec. 21, 2002 (DE) 102 60 426.0

(51) Int. Cl. F16H 55/08

(52) U.S. Cl. 74/457; 74/462

(57) ABSTRACT

A steering pinion (1) manufactured with finished toothing by cold or hot forming in the form of a one-piece coupling linkage between steering shaft (6) and rack (4) of a steering mechanism on a motor vehicle, wherein the steering pinion (1) is provided with a cylindrical toothed portion (3) having helical toothing on its outside and with a collinearly adjoining cylindrical journal portion, whose diameter is larger than that of the toothed portion and whose end portion contains a driver recess for connection of the steering shaft (6). A transition region between the root circle of the helical toothing and the journal portion (2) comprises at least two conical portions, namely a radially outer conical portion having a first cone angle (α₁) (die angle), which is disposed between the tip diameter at the toothing end of the helical toothing and the journal portion (2), and a radially inner conical portion having a second cone angle (α₂) (entrance angle) , which is disposed between the tip diameter at the toothing end and the root circle of the helical toothing.

The invention relates to a steering pinion manufactured with finished toothing by cold or hot forming in the form of a one-piece coupling linkage between steering shaft and rack of a steering mechanism on a motor vehicle, wherein the steering pinion is provided with a cylindrical toothed portion having helical toothing on its outside and with a collinearly adjoining cylindrical journal portion, whose diameter is larger than that of the toothed portion and whose end portion contains a driver recess for connection of the steering shaft, and wherein a transition region is provided between the root circle of the helical toothing and the journal portion.

Steering pinions of this type are described in Japanese Patents 7-308729 A and 11-10274 A. For control of material flow during forging, they provide an approximately triangular face, which is disposed within the hollow mold of the forging die in the entry region of the toothing flights. This triangular face is inclined in such a way that it expands the entry region and also sets the material flow in rotation, so that better filling of the mold cavities forming the helical toothing is achieved. In connection with these known proposed solutions, a problem that has not yet been considered is that, despite good filling of the cavity for the toothed member, uniform filling of the cavity for the journal portion is not assured, especially if a driver recess having a large area compared with the outside diameter of the journal portion is provided.

In contrast to the foregoing, the object of the present invention is to provide a geometry of the steering pinion such that the corresponding cavity of the die used for forming favors material flow in two opposite directions, namely for filling the cylindrical toothed portion on the one hand and the collinearly adjoining journal portion of the steering pinion on the other hand.

The shaping of the steering pinion with which this object is achieved is evident from the body of claim 1 of the present invention. According to that claim it is provided that the transition region between the root circle of the helical toothing and the journal portion of larger diameter comprises at least two conical portions, namely a radially outer conical portion having a first cone angle α₁ (die angle), which extends between the tip diameter at the toothing end of the helical toothing and the journal portion, and a radially inner conical portion having a second cone angle α₂ (entrance angle), which extends between the tip diameter at the toothing end and the root circle of the helical toothing, that the die angle α₁ is larger than or equal to the entrance angle α₂ and that the transition region describes at least one rounded portion having a first radius R1, which bridges between the outer conical portion and the cylindrical outside surface of the journal portion.

Such a design of the steering pinion ensures that the flow resistance during forming of the said pinion can be controlled in such a way by suitable choice of die angle α₁ and entrance angle α₂ that complete filling of the die cavities is ensured. For use of the inventive teaching, the resistance during pressure application can be adjusted such that the material of the blank flows in the two opposite directions in a manner matched to one another. In this connection, it is a preferred objective that, during complete filling of the journal portion, the elongated flights of the helical toothing also be completely filled out in the region of the toothed portion. An important fact in connection with the present invention is that, by suitable choice of the inlet resistance into the toothed portion, the material is pressed in the opposite direction with generation of an adequate back-pressure. Thereby there can be achieved flawless filling of the journal portion even in the case of a driver recess of relatively large dimensions.

According to an inventive proposal, it is provided that the die angle α₁ is determined in such a way as a function of the cross section of the driver recess that, relative to the outside diameter of the journal portion, it increases or decreases in the same sense with the dimension of the cross section of the driver recess. Thus, if the cross-sectional ratio between driver recess and journal portion is increased, it will be preferable to choose a correspondingly larger die angle α₁.

For dimensioning of the entrance angle α₂, it is provided according to the invention that this will be determined in such a way as a function of the helix angle β of the helical toothing that it increases or decreases in the opposite sense with a change in helix angle β. In this way the influence of helix angle β on flow resistance is balanced out, thus making it possible to match the material flow toward the toothing with that in the opposite direction, or in other words toward the journal portion.

Within the scope of the invention, there can be provided, besides the outer conical portion and the inner conical portion as well as the rounded portion with a first radius R1, still further rounded portions, so that smooth transitions for steady material flow are assured. In this context, there is preferably provided a rounded portion with a second radius R2, which forms the transition between the outer and inner conical portions. Furthermore, there can be provided another rounded portion with a third radius R3, which bridges between the inner conical portion and the root circle of the helical toothing. In this way there is produced a quasi-transition region with a turning point at the height of the tip diameter at the toothing end, provided the entrance angle α₂ is smaller than the die angle α₁. The two conical portions lie on a line only when the two angles are equal. Starting from the rule underlying the inventive teaching, to the effect that α₁ is greater than or equal to α₂, it is found in the case of unequal angles that the radii R1 and R2 are curved in opposite direction. Radius R3 has the same direction of curvature as radius R2. For radius R3, therefore, the same situation as for radius R2 applies in regard to R1, meaning that radii R1 and R3 are curved in opposite directions.

It is self evident for the person skilled in the art that, from the form of the steering pinion defined in the claims according to the present invention, there is automatically obtained a corresponding hollow mold of the die for the forming process. As an alternative to cold extrusion, forming can also be accomplished by forging.

The inventive steering pinion will be described hereinafter with reference to the drawing, wherein

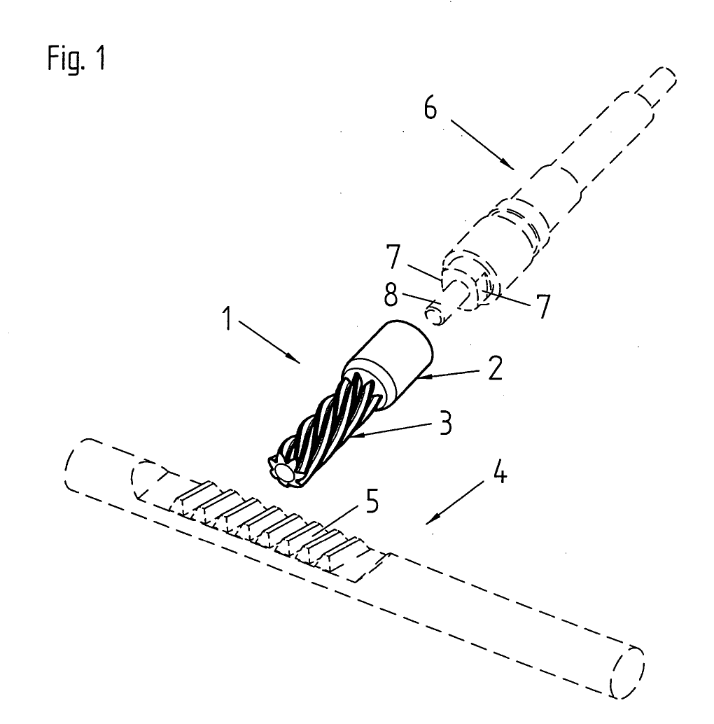

FIG. 1 shows a three-dimensional diagram of the steering pinion,

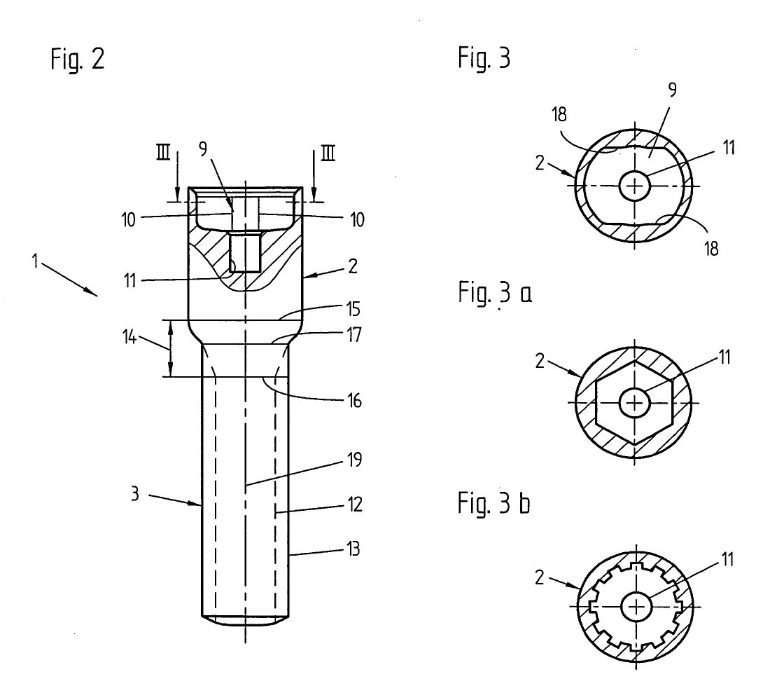

FIG. 2 shows a partly cutaway side view of the steering pinion,

FIG. 3 shows a cross section III-III according to FIG. 2, with a driver recess in the form of a profile having two faces,

FIG. 3a shows an alternative version of FIG. 3, with a driver recess in the form of a hexagonal profile,

FIG. 3b shows an alternative version of FIG. 3, with a driver recess in the form of a spline,

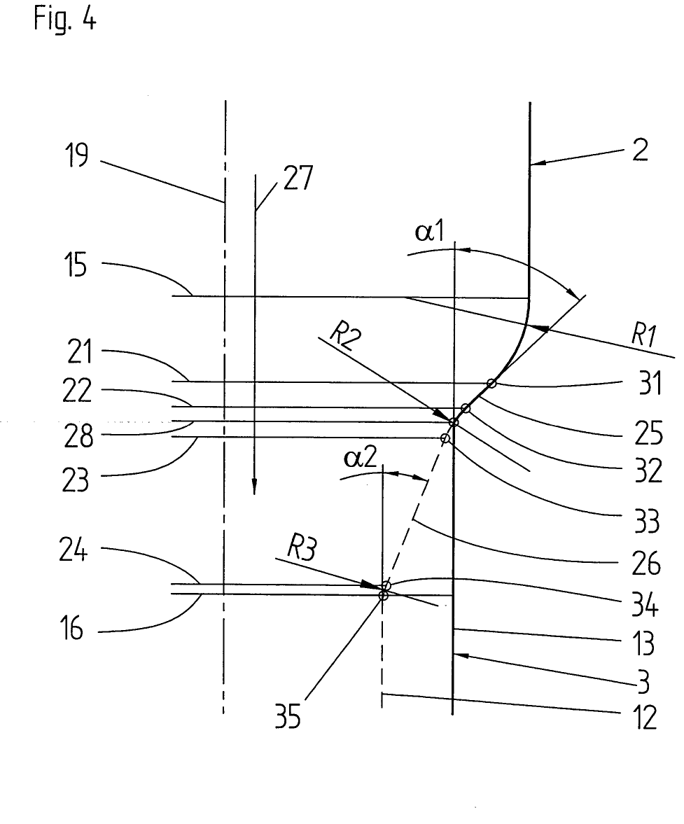

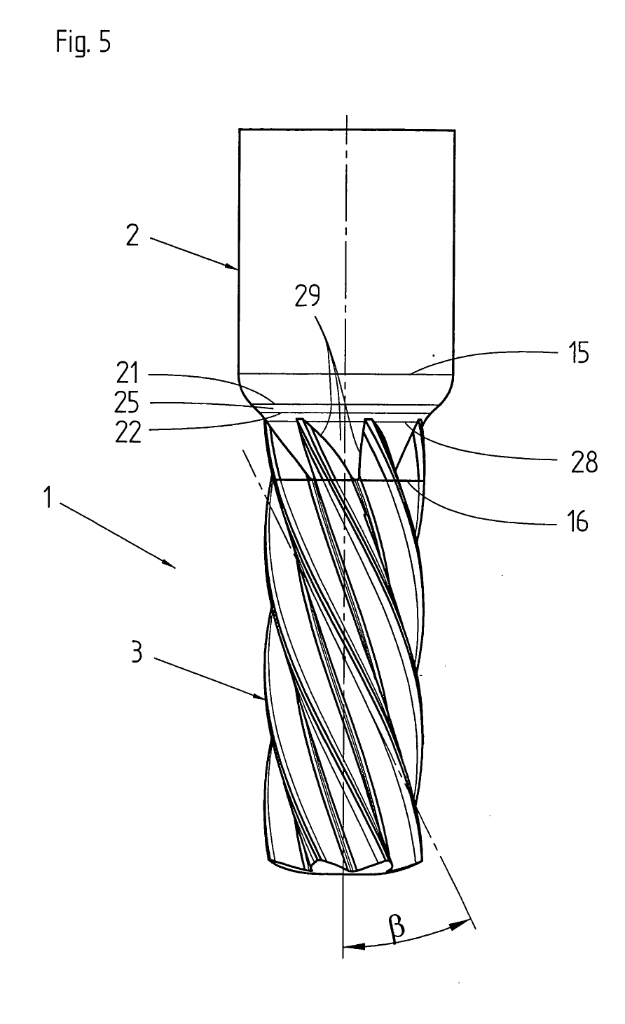

FIG. 4 shows a schematic diagram of the transition region between journal portion and toothed portion, and

FIG. 5 shows an enlarged side view in perspective.

FIG. 1 shows a three-dimensional diagram of an inventive steering pinion 1. It has a cylindrical journal portion 2 and, in the collinear extension thereof, a toothed portion 3, which is also cylindrical and which has a twisted or helical toothing that extends over its entire length. With steering pinion 1 there is associated, as illustrated by a broken outline, a rack 4 for a steering mechanism in a motor vehicle, the said rack having a toothed section 5. In a finished steering mechanism, the helical toothing of steering pinion 1 engages in rack 4 and displaces it according to the steering deflection, which is transmitted via the steering column of the vehicle to a steering shaft 6, illustrated as a broken outline. At its end next to steering pinion 1, steering shaft 6 has two oppositely disposed flats 7, which form key faces for coupling with a driver recess 9—not visible in FIG. 1 but shown in FIGS. 2 and 3 of the drawing—in the end of journal portion 2 next to the steering shaft. At its coupling end, moreover, steering shaft 6 has a cylindrical centering projection 8, which is inserted into a corresponding bore 11 (FIG. 2) in the center of driver recess 9 (FIG. 2). Bore 11 can be made either by forming or by subsequent machining by a chip-removing method.

In the side view according to FIG. 2, driver recess 9 is illustrated in the region of journal portion 2. By means of bounding lines 10, FIG. 3 shows a flat contact face 18, against which there bear key faces 7 of steering shaft 6 almost without play, as well as a bore 11 for receiving centering pin 8 of steering shaft 6. The helical toothing of toothed portion 3 of steering pinion 1 is illustrated schematically in the standard form, wherein broken line 12 corresponds to the root circle of the toothing and envelope line 13 to the tip circle. At the inner end of toothed portion 3 there is indicated, between lines 15 and 16, transition region 14 between the cylindrical part of journal portion 2 and toothed portion 3 as well as circumferential line 17, which denotes the toothing end.

FIG. 3 corresponds to section plane III-III in FIG. 2. It shows the relatively large cross-sectional area—illustrated without broken outlines—of driver recess 9, contact faces 18 for lateral key faces 7 of steering shaft 6, and central bore 11.

FIGS. 3a and 3b show alternatives to FIG. 3. Specifically, FIG. 3a shows a driver recess whose key faces are formed by a hexagon profile, and FIG. 3b shows a driver recess formed as a kind of internal spline.

FIG. 4 schematically illustrates the principle of the inventive solution. It is a diagram of steering pinion 1 in transition region 14 as a half section through longitudinal axis 19. In order to establish the relationship to FIG. 2, the boundaries of transition region 14 as defined by upper line 15 and lower line 16 are illustrated. The height of upper line 15 is defined by the transition between radius R1 and the cylindrical outside surface of journal portion 2. Lower bounding line 16 is defined by the transition of radius R3 to root diameter 12. Also shown is envelope line 13—which corresponds to the tip diameter of the toothing—of toothed portion 3. Hereinafter an explanation will be given of the significance of four further horizontal lines 21 to 24, which run parallel to bounding lines 15, 16 of transition region 14, namely within the said region. They are used for a detailed description of the transition region as defined in claim 1.

Together with the contour of the transition region, line 21 generates an intersection point 31 in the transition between the curvature according to radius R1 and a radially outer conical portion 25, whose cone angle is denoted as die angle α₁. The height of line 22 is defined by intersection point 32 between the inner end of outer conical portion 25 and radius R2, which runs through envelope line 13 corresponding to the tip diameter of toothed portion 3 and forms the transition to a radially inner conical portion 26. Intersection point 33 between radius R2 and radially inner conical portion 26 defines the height of line 23. The radially inner end of inner conical portion 26 is marked by intersection point 34 on line 24. Starting from intersection point 34, radius R3, which is curved in the same direction as radius R2, forms the transition to envelope line 12, which corresponds to the root diameter of the toothing. Together with envelope line 12, line 16, which bounds transition region 14 within toothed portion 3, generates intersection point 35, which forms the end point of the contour of transition region 14. In this way there is defined a transition region 14, composed of two conical portions 25, 26 and three radii R1, R2, R3. Of those, only radius R1, which bridges the large change in diameter between journal portion 2 and toothed portion 3, is important. It is entirely conceivable that radii R2 and R3 can be omitted, especially if die angle α₁ and entrance angle α₂ do not differ greatly from one another. In such a case, intersection points 32 and 33 migrate to positions above one another, and so they eventually become located on envelope line 13 corresponding to tip circle 13 of the toothing, and intersection point 34 migrates to a position above intersection point 35 on adjacent bounding line 16 of transition region 14.

Assuming the direction of material flow for filling toothed portion 3 during cold extrusion is the direction indicated by arrow 27, outer conical portion 25 means that the inlet resistance increases with the value of die angle α₁. Only if this resistance zone is overcome does the entrance angle α₂, which is usually smaller, determine the further flow resistance of the material during filling of the hollow mold forming the helical toothing. The smaller the value chosen for entrance angle α₂, the more rapidly is toothed portion 3 filled. However, it must be noted here that entrance angle α₂ depends on helix angle β of the helical toothing (see FIG. 5), specifically in such a way that entrance angle α₂ increases or decreases in the opposite sense of a change in helix angle β. Thus an increase of helix angle β is compensated for by a smaller entrance angle α₂, whereby the entrance resistance decreases, and vice versa.

FIG. 5 is an enlarged diagram showing the helical toothing in the region of toothed portion 3 as well as helix angle β. Lines 15 and 16 bound transition region 14 in accordance with the definition explained with reference to FIGS. 2 and 4. Line 28 denotes the end of the helical toothing next to journal portion 2. Radially outer conical portion 25 runs between lines 21 and 22.

To the shape of the hollow mold of the die in the entry region of toothed portion 3 there corresponds the approximately triangular face 29, which corresponds to radially inner conical portion 26, whose inclination is defined by entrance angle α₂. This triangular shape 29 forms the bridge between the entrance region and the actual helical toothing.

1. A steering pinion (1) manufactured with finished toothing by cold or hot forming in the form of a one-piece coupling linkage between steering shaft (6) and rack (4) of a steering mechanism on a motor vehicle, wherein the steering pinion (1) is provided with a cylindrical toothed portion (3) having helical toothing on its outside and with a collinearly adjoining cylindrical journal portion, whose diameter is larger than that of the toothed portion and whose end portion contains a driver recess (9) for connection of the steering shaft (6), and wherein a transition region (14) is provided between the root circle (12) of the helical toothing and the journal portion (2), characterized in that
the transition region (14) comprises at least two conical portions, namely a radially outer conical portion (25) having a first cone angle (α₁) (die angle), which is disposed between the tip diameter (13) at the toothing end of the helical toothing and the journal portion (2), and a radially inner conical portion (26) having a second cone angle (α₂) (entrance angle) , which is disposed between the tip diameter (13) at the toothing end and the root circle (12) of the helical toothing, in that the die angle (α₁) is larger than or equal to the entrance angle (α₂) and in that the transition region (14) describes at least one rounded portion having a first radius (R1), which bridges between the outer conical portion (25) and the cylindrical outside surface of the journal portion (2).

2. A steering pinion according to claim 1, characterized in that
the die angle (α₁) is determined in such a way as a function of the hollow cross section of the driver recess (9) that, relative to the outside diameter of the journal portion (2), it (α₁) increases or decreases in the same sense with the dimension of the cross section of the driver recess.

3. A steering pinion according to claim 1, characterized in that
the entrance angle (α₂) is determined in such a way as a function of the helix angle (β) of the helical toothing that it (α₂) increases or decreases in the opposite sense with a change in the helix angle.

4. A steering pinion according to claim 1, characterized in that
the transition region (14) describes a rounded portion having a second radius (R2), which forms the transition between the outer conical portion (25) and the inner conical portion (26).

5. A steering pinion according to claim 1, characterized in that
the transition region (14) describes a rounded portion having a third radius (R3), which bridges between the inner conical portion (26) and the root circle (12) of the helical toothing.
